(19) United States
(12) Patent Application Publication
(10) Pub. No.: US 2024/0404732 A1
(43) Pub. Date: Dec. 5, 2024

(54) MULTICORE CABLE

(71) Applicant: Proterial, Ltd., Tokyo (JP)

(72) Inventors: Detian HUANG, Tokyo (JP); Takanobu WATANABE, Tokyo (JP); Atsuro YAGUCHI, Tokyo (JP); Kimika KUDO, Tokyo (JP)

(21) Appl. No.: 18/531,006

(22) Filed: Dec. 6, 2023

(30) Foreign Application Priority Data
May 31, 2023 (JP) 2023-090315

(51) Int. Cl. H01B 9/02; H01B 7/00

(52) U.S. Cl. CPC H01B 9/025; H01B 7/0009

(57) ABSTRACT

A multicore cable is provided with coaxial cables, each of which includes an inner conductor, an insulator covering around the inner conductor, and an outer conductor arranged around the insulator. The outer conductor is exposed, and the outer conductors of some of the coaxial cables are covered by grounding conductors that are to be electrically grounded. Each of the outer conductors of the coaxial cables is electrically grounded by contacting the grounding conductor or the outer conductor of another one of the coaxial cables.

### CROSS-REFERENCE TO RELATED APPLICATIONS

The present application is based on Japanese patent application No. 2023-090315 filed on May 31, 2023, the entire contents of which are incorporated herein by reference.

### TECHNICAL FIELD

The present invention relates to a multicore cable which has plural coaxial cables.

### BACKGROUND OF THE INVENTION

Conventionally, a multicore cable having plural coaxial cables is used, e.g., for communications. A multicore communication cable according to Patent Literature 1 includes a core material made of a fiber string made of plural fibers or a fiber bundle made of plural fiber strings bundled together, plural coaxial electric wires arranged around an outer periphery of the core material, a binder tape which wraps and bundles the plural coaxial electric wires, a shield layer which covers the binder tape, and a tubular sheath which covers the shield layer. The coaxial electric wire has a center conductor, an insulator, an outer conductor made of plural thin metallic wires spirally wound, and a jacket made of a resin tape with a fusion layer spirally wound in such a manner that the fusion layer is located at the outer conductor side.

### Citation List Patent Literature 1: JP2020-21713A

### SUMMARY OF THE INVENTION

A multicore cable which is used, e.g., as an inner cable inside a multijoint robot or as a cable for an endoscope or a medical catheter, is expected to have great flexibility and a small cable diameter. The present invention is made to respond to the need, and the object of the present invention is to supply a multicore cable which can be reduced in diameter and have great flexibility.

For solving the aforementioned problems, the present invention provides a multicore cable comprising:

coaxial cables, each comprising an inner conductor, an insulator covering around the inner conductor, and an outer conductor arranged around the insulator, the outer conductor being exposed,
wherein the outer conductors of some of the coaxial cables are covered by grounding conductors that are to be electrically grounded, and
wherein each of the outer conductors of the coaxial cables is electrically grounded by contacting the grounding conductor or the outer conductor of another one of the coaxial cables.

### Advantageous Effects of the Invention

According to the present invention, it is possible to provide a multicore cable which can be reduced in cable diameter and have great flexibility.

### BRIEF DESCRIPTION OF DRAWINGS

FIG. 1 is a cross-sectional view illustrating a multicore cable according to the first embodiment of the present invention.

FIG. 2A is a configuration diagram explaining a configuration of a coaxial cable.

FIG. 2B is a cross-sectional view along the line A-A in FIG. 2A.

FIG. 3A is a configuration diagram explaining configurations of a first coaxial cable and a grounding conductor.

FIG. 3B is a cross-sectional view along the line B-B in FIG. 3A.

FIG. 4 is an explanatory diagram illustrating a structure of the first to eighth coaxial cables, viewing perpendicularly in a longitudinal direction of the multicore cable, omitting a tape member, a shield layer, and a sheath.

FIG. 5A is a schematic diagram illustrating a configuration example of a device system where a device at one side and a device at the other side are electrically connected by a composite multicore cable using plural multicore cables.

FIG. 5B is a cross-sectional view along the line C-C of the composite multicore cable in FIG. 5A.

FIG. 6 is a configuration diagram illustrating an example where inner conductors and grounding conductors of a coaxial cable of one multicore cable are respectively connected to plural electrodes on a substrate of a device on the other side.

FIG. 7 is a cross-sectional view illustrating a multicore cable according to the second embodiment of the present invention.

FIG. 8 is a cross-sectional view illustrating a multicore cable according to the third embodiment of the present invention.

FIG. 9 is a cross-sectional view illustrating a multicore cable according to the fourth embodiment of the present invention.

FIG. 10 is a cross-sectional view illustrating a multicore cable according to the fifth embodiment of the present invention.

### DETAILED DESCRIPTION OF THE INVENTION

### First Embodiment

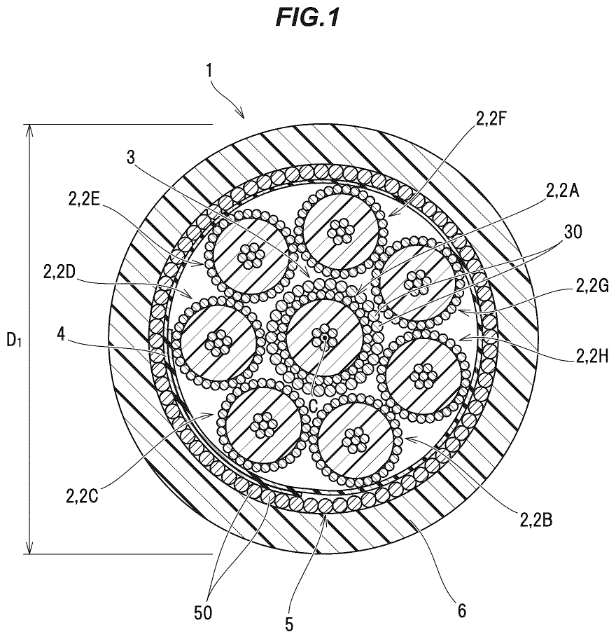

FIG. 1 is a cross-sectional view illustrating a multicore cable 1 according to the first embodiment of the present invention. FIG. 1 shows a cross-section perpendicular to the longitudinal direction of the multicore cable 1. The multicore cable 1 is used, e.g., as a cable of an endoscope or a medical catheter or as an inner cable inside a multijoint robot.

The multicore cable 1 includes plural coaxial cables 2, a grounding conductor 3 for electrical grounding, a tape member 4 spirally wound around the plural coaxial cables 2 and the grounding conductor 3, a shield layer 5 made of plural shield wires 50 spirally wound around the tape member 4, and a tubular sheath 6 covering an outer periphery of the shield layer 5. In the present embodiment, eight coaxial cables 2 with the grounding conductor 3 are collectively accommodated in the sheath 6.

As the tape member 4, a tape made of woven fabric, paper, or resin or the like, can be used, for example. The shield wires 50 are made of, e.g., silver-plated or tin-plated annealed copper wires or copper alloy wires and arranged between the tape member 4 and the sheath 6. The sheath 6 is made of, e.g., an extruded resin composition including fluorocarbon resin or polyvinylchloride resin and protects what is inside. An outer diameter of the sheath 6, in other words, an outer diameter D₁ of the multicore cable 1 (cable outer diameter) is 1.0 mm or less.

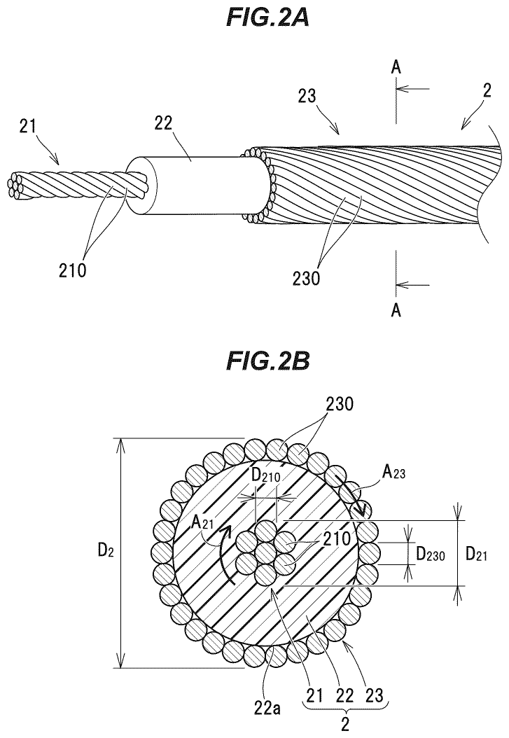

FIG. 2A is a configuration diagram explaining a configuration of the coaxial cable 2. FIG. 2B is a cross-sectional view along the line A-A in FIG. 2A. The coaxial cable 2 includes an inner conductor 21, an insulator 22 covering around the inner conductor 21, and an outer conductor 23 arranged around the insulator 22. An outer periphery of the outer conductor 23 of the coaxial cable 2 is not covered by an insulator, so the outermost layer of the coaxial cable 2 is the outer conductor 23. In other words, the coaxial cable 2 is a non-coating type coaxial cable with the outer conductor 23 being exposed. An outer diameter D₂ of the coaxial cable 2 is 0.2 mm or less.

The inner conductor 21 is a stranded wire made of plural inner conductor wires 210 stranded together. In the present embodiment, the inner conductor 21 is configured by seven inner conductor wires 210 stranded together. The inner conductor wires 210 are, e.g., copper alloy wires or tin-plated copper alloy wires. An outer diameter D21 of the inner conductor 21 is 0.1 mm or less. An outer diameter D210 of the inner conductor wire 210 is 0.033 mm or less.

The insulator 22 is made of, e.g., fluorocarbon resin, polyethylene, or polypropylene or the like. As a fluorocarbon resin used for the insulator 22, more specifically, PFA (tetrafluoroethylene-perfluoroalkyl vinyl ether copolymer) can be used suitably, for example. The inner conductor 21 is arranged at the center of the insulator 22.

The outer conductor 23 is made of plural outer conductor wires 230 spirally wound around an outer periphery of the insulator 22. The plural outer conductor wires 230 are spirally wound in contact with an outer periphery surface 22a of the insulator 22. In the present embodiment, the outer conductor 23 is configured by thirty outer conductor wires 230 as an example. The outer conductor wires 230 are, e.g., copper alloy wires or tin-plated copper alloy wires. An outer diameter D₂₃₀ of the outer conductor wire 230 is 0.033 mm or less, as an outer diameter D₂₁₀ of the inner conductor wire 210.

The outer diameters of the multicore cable 1, the coaxial cable 2, the inner conductor 21, the inner conductor wire 210, the outer conductor wire 230, and a grounding conductor wire 30 can be measured by using, e.g., a caliper, micrometer, or microscope, and in a method in compliance with JIS C 3005. The same applies to an outer diameter of the grounding conductor 3 and an outer diameter of the grounding conductor wire 30 that will be described later. In the present embodiment, the thickness and material of the plural coaxial cables 2 of the multicore cable 1 are common in specifications, but alternatively, specifications of some coaxial cables 2 may be different from those of other coaxial cables 2.

A spiral winding direction of the plural outer conductor wires 230 viewed in the longitudinal direction of the coaxial cable 2 is the same as a twisting direction of the plural inner conductor wires 210 of the inner conductor 21. In FIG. 2B, the twisting direction of the inner conductor wires 210 is indicated by a curved arrow A₂₁, and the spiral winding direction of the outer conductor wires 230 is indicated by a curved arrow A₂₃. The twisting direction of the inner conductor wires 210 and the spiral winding direction of the outer conductor wires 230 are common for all the coaxial cables 2.

Hereinafter, to identify the eight coaxial cables 2, the coaxial cables 2 are explained as the first to eighth coaxial cables 2A to 2H. The coaxial cables 2 is a collective name for the first to eighth coaxial cables 2A to 2H.

The first coaxial cable 2A is arranged at the center of the sheath 6, and the second to eighth coaxial cables 2B to 2H are arranged in proximity to the sheath 6. Also, the second to eighth coaxial cables 2B to 2H are arranged around the first coaxial cable 2A. The tape member 4 is spirally wound around in contact with the second to eighth coaxial cables 2B to 2H.

The grounding conductor 3 covers the outer periphery of some coaxial cables 2 of the plural coaxial cables 2. Each outer conductor 23 of the plural coaxial cables 2 is electrically grounded by contacting the grounding conductor 3 or the outer conductor 23 of other coaxial cables 2. In the present embodiment, the outer periphery of the first coaxial cable 2A is covered by the grounding conductor 3, but the second to eighth coaxial cables 2B to 2H are not covered by the grounding conductor 3. Among the second to eighth coaxial cables 2B to 2H, the outer conductors 23 of adjacent coaxial cables 2 are in contact with one another at least partially in the longitudinal direction of the multicore cable 1. Also, each outer conductor 23 of the second to eighth coaxial cables 2B to 2H is in contact with the grounding conductor 3 at least partially in the longitudinal direction of the multicore cable 1.

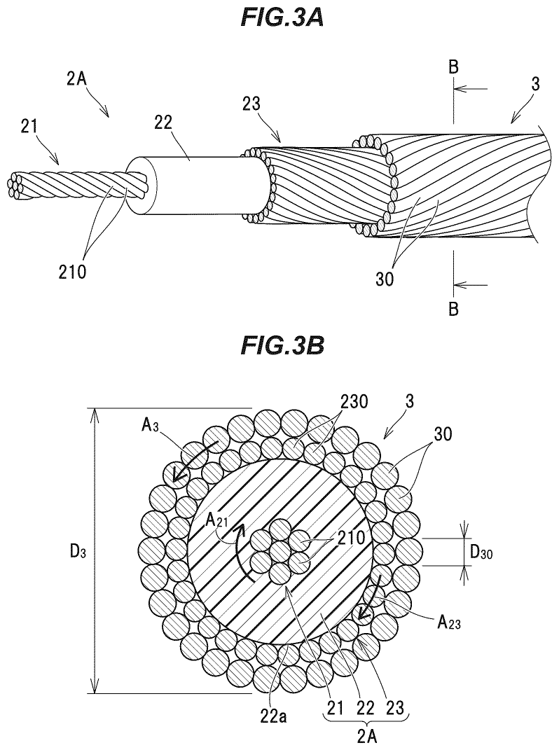

FIG. 3A is a configuration diagram explaining configurations of the first coaxial cable 2A and the grounding conductor 3. FIG. 3B is a cross-sectional view along the line B-B in FIG. 3A. The grounding conductor 3 is made of plural grounding conductor wires 30 spirally wound. The plural grounding conductor wires 30 are made of, e.g., copper alloy wires or tin-plated copper alloy wires, and are spirally wound on the outer periphery of the outer conductor 23 of the first coaxial cable 2A. An outer diameter D₃₀ of the grounding conductor wire 30 is 1.0 times or more and 1.5 times or less of the outer diameter D₂₃₀ of the outer conductor wires 230. Due to this, the increase of the cable outer diameter can be controlled, while grounding resistance of the outer conductor 23 is reduced. More preferably, the outer diameter D₃₀ of the grounding conductor wire 30 is more than 1.0 times and 1.5 times or less of the outer diameter D₂₃₀ of the outer conductor wire 230. Due to this, the grounding resistance of the outer conductor 23 can be further reduced, and at the same time, the outer conductor wires 230 and the grounding conductor wires 30 can be easily separated while performing terminal processing of the multicore cable 1. The outer diameter of the grounding conductor 3 (in other words, the outer diameter of the first coaxial cable 2A) D₃ is 1.2 or more and 1.4 or less of the outer diameter D₂ of the coaxial cable 2.

In an example shown in FIG. 3B, the number of the outer conductor wires 230 and the number of the grounding conductor wires 30 are the same, and the outer diameter D₃₀ of the grounding conductor wire 30 is 1.25 times of the outer diameter D₂₃₀ of the outer conductor wire 230, but the number of the outer conductor wires 230 and the number of the grounding conductor wires 30 may be different from each other.

The spiral winding direction of the plural grounding conductor wires 30 viewed in the longitudinal direction of the first coaxial cable 2A is opposite to the spiral winding direction of the plural outer conductor wires 230 of the outer conductor 23. In FIG. 3B, the twisting direction of the grounding conductor wires 30 is indicated by a curved arrow A₃. Because the spiral winding direction of the grounding conductor wires 30 is opposite to the spiral winding direction of the outer conductor wires 230, the outer conductor wires 230 and the grounding conductor wires 30 can be easily separated while performing the terminal processing of the multicore cable 1, and as a result, workability is improved. Additionally, a pitch of the spiral winding of the plural grounding conductor wires 30 (a pitch of the first coaxial cable 2A in the longitudinal direction when spirally wound) is different from a pitch of spiral winding of the plural outer conductor wires 230 that configure the outer conductor 23. For example, it is preferable that the pitch of the spiral winding of the grounding conductor wires 30 is larger than the pitch of the spiral winding of the outer conductor wires 230. Due to this, the outer conductor wires 230 and the grounding conductor wires 30 can be easily separated while performing the terminal processing of the multicore cable 1.

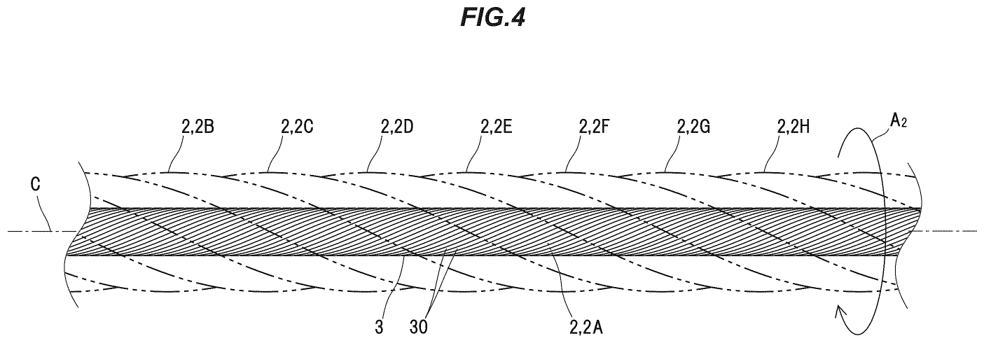

FIG. 4 is an explanatory diagram illustrating a structure of the first to eighth coaxial cables 2A to 2H, seen perpendicularly in the longitudinal direction of the multicore cable 1, with the tape member 4, the shield layer 5, and the sheath 6 omitted. In FIG. 4, the grounding conductor 3 covering the first coaxial cable 2A is illustrated by solid line, while the second to eighth coaxial cables 2B to 2H are illustrated schematically by virtual line (dash-dot-dot line).

The first coaxial cable 2A is arranged at the center of the sheath 6 along the center axis C of the sheath 6. The second to eighth coaxial cables 2B to 2H are arranged spirally to wrap the first coaxial cable 2A and the grounding conductor 3. The spiral winding direction of the second to eighth coaxial cables 2B to 2H is opposite to the winding direction of the plural grounding conductor wires 30, viewed in the longitudinal direction of the multicore cable 1 (in other words, the same as the winding direction of the plural outer conductor wires 230). In FIG. 4, the winding direction of the second to eighth coaxial cables 2B to 2H is indicated by a curved arrow A2. By making the winding direction of the second to eighth coaxial cables 2B to 2H opposite to the winding direction of the plural grounding conductor wires 30, the spirally wound plural outer conductor wires 230 of the second to eighth coaxial cables 2B to 2H will not easily fall apart. Therefore, the functional degradation of an electromagnetic shield can be controlled. However, the spiral winding direction of the second to eighth coaxial cables 2B to 2H may be the same as the spiral winding direction of the plural grounding conductor wires 30.

The outer conductor 23 of the first coaxial cable 2A is electrically grounded by contacting the grounding conductor 3. Other coaxial cables 2 (the second to eighth coaxial cables 2B to 2H) can be electrically grounded when at least one outer conductor 23 of any of the coaxial cables 2 contacts the grounding conductor 3, and not all of the outer conductors 23 of the coaxial cables 2 are required to contact the grounding conductor 3. In other words, each outer conductor 23 of the second to eighth coaxial cables 2B to 2H is electrically grounded by contacting the grounding conductor 3, or by contacting the outer conductor 23 of the coaxial cable 2 arranged side by side in the spiral winding direction of the second to eighth coaxial cables 2B to 2H.

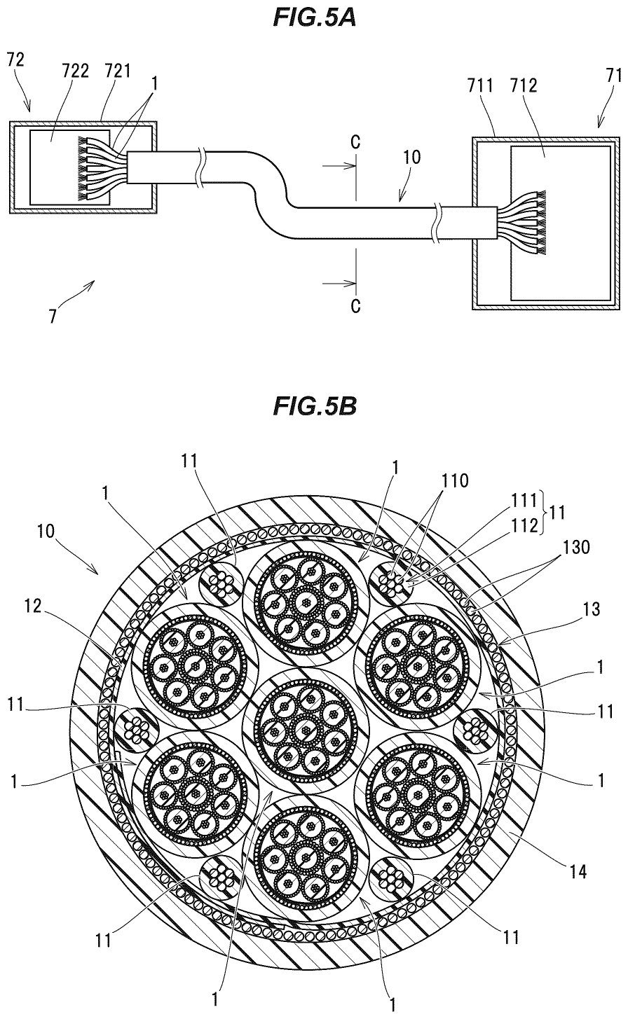

FIG. 5A is a diagram illustrating a configuration example of a device system 7 where a device 71 connected to one end of a composite multicore cable 10 at one side and the composite multicore cable 10 and a device 72 connected to the other end of the composite multicore cable 10 at the other side are electrically connected by using the composite multicore cable 10 that is configured by plural multicore cables 1 according to the present embodiment. FIG. 5B is a cross-sectional view of the composite multicore cable 10 along the line C-C in the FIG. 5A. The composite multicore cable 10 is repeatedly bent at plural locations in the longitudinal direction. The device 72 at the other end is, e.g., a camera head of an endoscope system or a catheter head of a catheter system which is inserted into a human body. Alternatively, the device 72 at the other end may be an actuator or sensor or the like of a multijoint robot or a machine tool.

The device 71 at one end and the device 72 at the other end respectively have case members 711 and 721 and substrates 712 and 722 arranged inside the case members 711 and 721. The inner conductor 21 and the grounding conductor 3 of each of the plural coaxial cables 2 of the plural multicore cables 1 are connected to electrodes mounted on the substrates 712 and 722. The substrates 712 and 722 can be, e.g., flexible substrates in a film form which have flexibility, or solid substrates that have higher stiffness than the flexible substrates. However, for the substrate 722 of the device 72 at the other end, it is preferable to use a flexible substrate which allows downsizing of the device 72 at the other end.

Additionally, it is not shown in the drawing, but both ends of each of the shield wires 50 of the plural multicore cables 1 are electrically connected to the case members 711 and 721 of the device 71 at one end and the device 72 at the other end. The case members 711 and 721 are made of metal and electromagnetically shields the substrates 712 and 722 and the like.

As shown in FIG. 5B, the composite multicore cable 10 includes the plural multicore cables 1, plural power lines 11, the tape member 12 that is spirally wrapped around the plural multicore cables 1 and the plural power lines 11, the shield layer 13 made of plural shield wires 130 that are spirally wrapped around the tape member 12, and a tubular outer sheath 14 that covers the outer periphery of the shield layer 13. The plural multicore cables 1 and plural power lines 11 are spirally stranded together. The power line 11 is a simple line that has a conductor line 111 made of plural wires 110 stranded together, and an insulator 112 that covers the conductor line 111. The conductor line 111 is, e.g., connected to a power electrode on the back of an opposite side of a surface where plural electrodes are connected to the inner conductor 21 and the grounding conductor 3 of the plural coaxial cables 2 on the substrates 712 and 722.

The inner conductor 21 in each of the coaxial cables 2 of the plural multicore cables 1 transmits electric signals between the device 71 at one end and the device 72 at the other end. The outer conductor 23 functions as an electromagnetic shield. The power lines 11 supplies power to the device 72 at the other end for electrical operation of the device 72 at the other end. FIG. 5B shows an example of the composite multicore cable 10 having seven multicore cables 1 and six power lines 11. However, the number of the multicore cables 1 and power lines 11 inside the composite multicore cable 10 may be appropriately selected according to a use, a function, and the like of the device system 7.

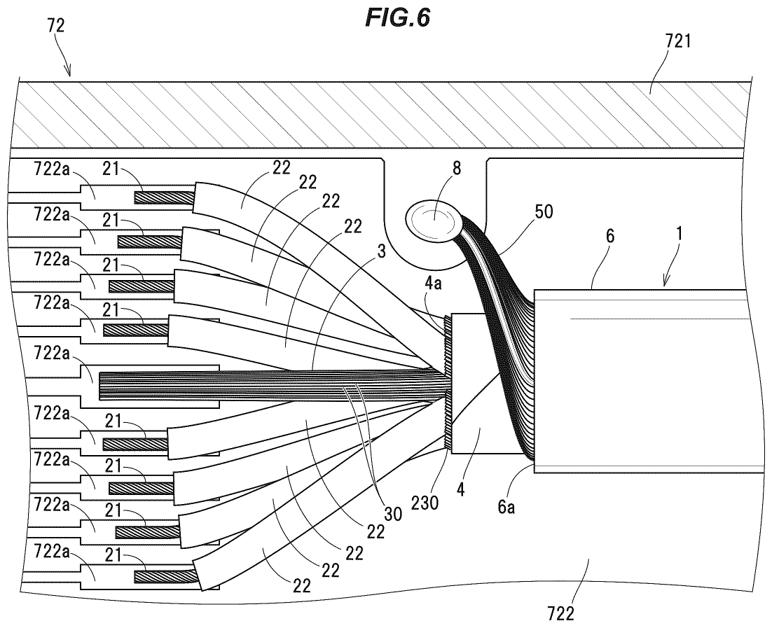

FIG. 6 is a configuration diagram illustrating an example where the inner conductors 21 and the grounding conductor 3 of the coaxial cables 2 inside the single multicore cable 1 are respectively connected to plural electrodes 722a that are mounted on the substrate 722 of the device 72 at the other end. Additionally, a connection between the substrate 712 of the device 71 at one end and the multicore cable 1 is performed in the same configuration shown in FIG. 6.

As shown in FIG. 6, the insulators 22 of the coaxial cables 2 are removed in the vicinity of the electrodes 722a and the inner conductors 21 are exposed. The plural grounding conductor wires 30 of the grounding conductor 3 are stranded at a section exposed from the sheath 6 and connected to the electrodes 722a. The inner conductors 21 and the grounding conductor 3 of the coaxial cables 2 are respectively connected to the plural the electrodes 722a by soldering, for example. In FIG. 6, an illustration of the soldering is omitted. The electrode 722a to which the grounding conductor 3 is connected is a ground electrode.

In addition, the connection between the inner conductors 21 and the electrodes 722a may be performed not only by soldering but also by using a conductive adhesive or welding. Furthermore, not all the plural grounding conductor wires 30 of the grounding conductor 3 need to be connected to the electrode 722a. For example, while half the number of the grounding conductor wires 30 among thirty grounding conductor wires 30 are connected to the electrode 722a, other grounding conductor wires 30 can be cut off in the vicinity of an end face 6a of the sheath 6. In other words, at least some of the plural grounding conductor wires 30 of the grounding conductor 3 need to be connected to the electrode 722a. Alternatively, plural (for example, 30) grounding conductor wires 30 may be divided into plural bundles and each bundle of the grounding conductor wires 30 may be connected to the plural electrodes 722a one by one. This enables grounding according to various configurations of the substrate 722.

The tape member 4 is cut off around an end face 6a of the sheath 6. The plural outer conductor wires 230 of each outer conductor 23 of the plural coaxial cables 2 are cut off in the vicinity of an end face 4a of the tape member 4. In other words, both ends of the plural outer conductor wires 230 of the plural coaxial cables 2 are cut off in the vicinity of the end of the tape member 4 and the sheath 6, at equal length to one another.

The plural shield wires 50 of the multicore cable 1 are derived from between the tape member 4 and the sheath 6 and stranded, and then electrically connected to a case member 721 by a solder 8. Alternatively, the plural shield wires 50 may be crimped against a connection terminal by swaging, and the connection terminal may be connected to the case member 721 by bolt fixing or swaging, for example. Alternatively, the plural shield wires 50 may be swaged at a swaging part formed on the case member 721.

### Advantageous Effects of the First Embodiment

According to the first embodiment explained above, because the outer periphery of the outer conductor 23 of each coaxial cable 2 is not covered, the outer diameter of the coaxial cable 2 can be reduced, and in addition, the outer diameter of the multicore cable 1 and the outer diameter of the composite multicore cable 10 can be reduced. Furthermore, because the outer conductor 23 of the coaxial cable 2 is not covered, the flexibility of the multicore cable 1 can be improved.

Furthermore, according to the first embodiment, each outer conductor 23 of the plural coaxial cables 2 is electrically grounded by contacting the grounding conductor 3 or the outer conductor 23 of another one of the coaxial cables 2. Therefore, compared with a grounding by connecting each outer conductor 23 of each coaxial cable 2 to the electrodes of the substrates 712 and 722 of the device 71 at one end and the device 72 at the other end, e.g., the system configuration can be simplified and man-hours for the operation can be reduced.

In addition, according to the first embodiment, the plural outer conductor wires 230 of each the outer conductor 23 of the plural coaxial cables 2, are cut off in equal lengths in the vicinity of the ends of the tape member 4 and the sheath 6, therefore, an impedance mismatch of each coaxial cable 2 can be prevented and degradation of signal quality can be controlled. In other words, if the outer conductor wires 230 of the first coaxial cable 2A are not cut off in the vicinity of the ends of the tape member 4 and the sheath 6 but derived (i.e., pulled out) long from the tape member 4 and connected to the electrodes 722a, an electric impact from the derived part of the outer conductor wires 230 may cause an impedance mismatch. By cutting off the outer conductor wires 230 of all the coaxial cables 2 of the multicore cable 1 in the vicinity of the ends of the tape member 4 and the sheath 6 as in the first embodiment, the occurrence of such a problem can be controlled.

Furthermore, the grounding conductor 3 is not limited to the plural grounding conductor wires 30 spirally wound around the outer periphery of the outer conductor 23 as shown in FIGS. 3A and 3B, but alternatively, it may be a cylindrical braided wire made of plural grounding conductor wires braided in a grid pattern, for example. The same is true for grounding conductors according to other embodiments described later.

### Second Embodiment

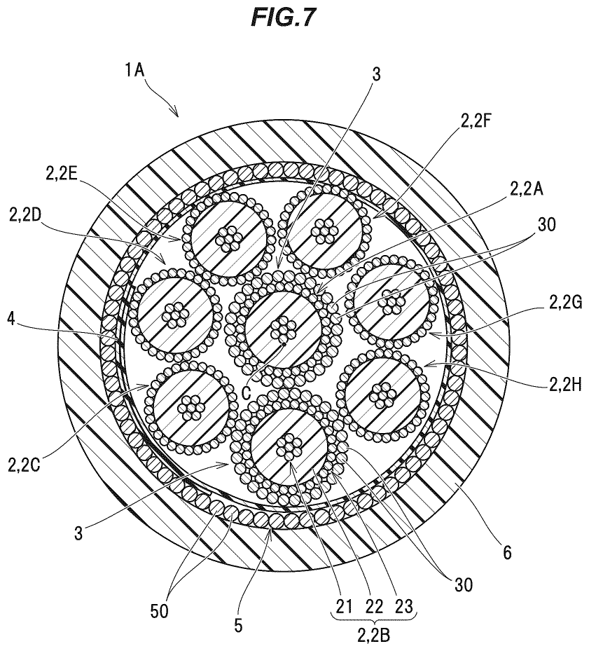

Next, the second embodiment of the present invention will be explained with reference to FIG. 7. FIG. 7 is a cross-sectional view illustrating a multicore cable 1A according to the second embodiment of the present invention. In the first embodiment, among the first to eighth coaxial cables 2A to 2H, the first coaxial cable 2A arranged at the center of the sheath 6 is covered by the grounding conductor 3. In the second embodiment, not only the first coaxial cable 2A, but also the second coaxial cable 2B that is arranged closer to the sheath 6 than the first coaxial cable 2A, is covered by the grounding conductor 3. The grounding conductor 3 covering the first coaxial cable 2A and the grounding conductor 3 covering the second coaxial cable 2B are in contact with each other. Other configurations of the multicore cable 1A are the same as the multicore cable 1 according to the first embodiment.

The outer conductors 23 of the first coaxial cable 2A and the second coaxial cable 2B are electrically grounded by contacting the grounding conductor 3 respectively. The outer conductor 23 of the third to eighth coaxial cables 2C to 2H is electrically grounded by contacting the grounding conductor 3 covering the outer periphery of the first coaxial cable 2A or the second coaxial cable 2B, or the outer conductor 23 of other coaxial cables 2. Each inner conductor 21 of the first to eighth coaxial cables 2A to 2H, the grounding conductor 3 covering the first coaxial cable 2A, and the grounding conductor 3 covering the second coaxial cable 2B are connected to the electrodes on the substrate at the end of the multicore cable 1A as in the first embodiment.

In addition to the advantageous effects of the first embodiment, the second embodiment allows easy connection of the grounding conductor 3 covering the second coaxial cable 2B to the electrode on the substrate by arranging the second coaxial cable 2B close to the substrate at the end of the multicore cable 1A. Furthermore, when the grounding conductor 3 covering the second coaxial cable 2B is connected to the electrode on the substrate and electrically grounded, the grounding conductor 3 covering the first coaxial cable 2A is not necessarily required to be connected to the electrode on the substrate. In this case, the grounding conductor 3 covering the first coaxial cable 2A is electrically grounded, because the grounding conductor 3 covering the first coaxial cable 2A and the grounding conductor 3 covering the second coaxial cable 2B are in contact with each other.

Alternatively, among the second to eighth coaxial cables 2B to 2H arranged in the vicinity of the sheath 6, the grounding conductor 3 may be arranged on the outer periphery of another one of the coaxial cables 2 in addition to the second coaxial cable 2B. In other words, it is sufficient when at least one coaxial cable 2 out of the plural coaxial cables 2 arranged in the vicinity of the sheath 6, is covered by the grounding conductor 3.

### Third Embodiment

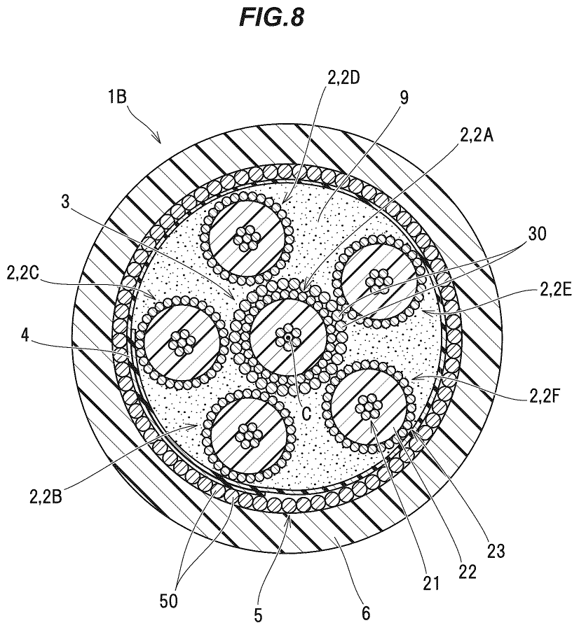

Next, the third embodiment of the present invention will be explained with reference to FIG. 8. FIG. 8 is a cross-sectional view illustrating a multicore cable 1B according to the third embodiment of the present invention. In the first and the second embodiments, the multicore cable 1 has eight coaxial cables 2, and one coaxial cable 2 is arranged at the center (the first coaxial cable 2A) while seven other coaxial cables 2 (the second to eighth coaxial cables 2B to 2H) are arranged around it. In the third embodiment, five coaxial cables 2 (the second to sixth coaxial cables 2B to 2F) are arranged around one coaxial cable 2 covered by the grounding conductor 3 (the first coaxial cable 2A).

A filler 9 is arranged between the five coaxial cables 2 so that the coaxial cables 2 can keep an even distance from one another and can avoid being placed unevenly. As the filler 9, a stringlike or fibrous material can be used. In addition, the filler 9 may be a conductive material. The presence of the filler 9 can make the outer shape of the sheath 6 close to a perfect circle shape and improve a routing ability and bending durability of the multicore cable 1B. The outer conductor 23 of each coaxial cable 2A is electrically grounded by contacting the grounding conductor 3.

In the third embodiment, the same advantageous effects as the first embodiment can be expected. In addition, it is preferable to arrange at least five coaxial cables 2 around the coaxial cable 2 arranged at the center (the first coaxial cable 2A). It is because that if the number of the coaxial cables 2 arranged around the single coaxial cable 2 at the center is four or less, the number of the coaxial cables 2 against the cable outer diameter is too small to maintain wiring efficiency. It is also because that the space between the coaxial cables 2 arranged around the single coaxial cable 2 could be bigger than the outer diameter D₃ of the grounding conductor 3, and the cable positioning could be disturbed (i.e., misaligned).

### Fourth Embodiment

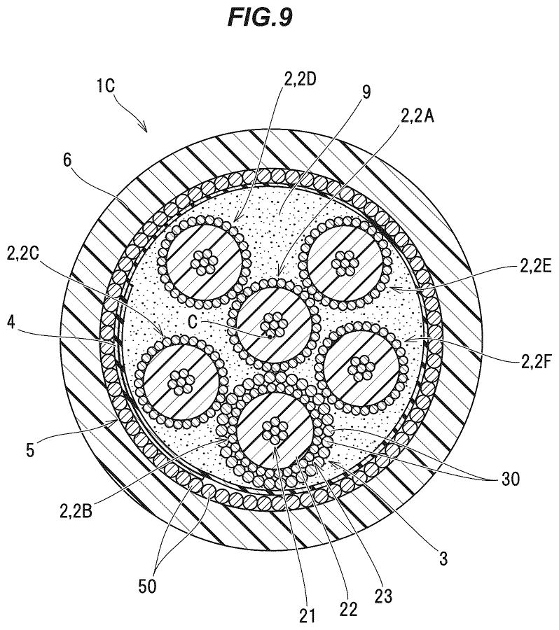

Next, the fourth embodiment of the present invention will be explained with reference to FIG. 9. FIG. 9 is a cross-sectional view illustrating a multicore cable 1C according to the fourth embodiment of the present invention. The multicore cable 1C according to the fourth embodiment has, as the multicore cable 1B according to the third embodiment, the five coaxial cables 2 (the second to sixth coaxial cables 2B to 2F) that are arranged around the single coaxial cable 2 arranged at the center (the first coaxial cable 2A). However, it is not the single coaxial cable 2 arranged at the center (the first coaxial cable 2A), but the outer conductor 23 of the second coaxial cable 2B located in the vicinity of the sheath 6 is covered by the grounding conductor 3. This configuration is different from the multicore cable 1B according to the third embodiment.

In the present embodiment, the outer conductor 23 of the first coaxial cable 2A, the outer conductor 23 of the second coaxial cable 2B, the outer conductor 23 of the third coaxial cable 2C, and the outer conductor 23 of the sixth coaxial cable 2F, are electrically grounded by contacting the grounding conductor 3. The outer conductor 23 of the fourth coaxial cable 2D is electrically grounded by contacting the outer conductor 23 of the first coaxial cable 2A or the third coaxial cable 2C. The outer conductor 23 of the fifth coaxial cable 2E is electrically grounded by contacting the outer conductor 23 of the first coaxial cable 2A or the sixth coaxial cable 2F.

By using the multicore cable 1C in which the second coaxial cable 2B is arranged in the vicinity of the substrate, the grounding conductor 3 covering the second coaxial cable 2B can be easily connected to the electrode on the substrate. Alternatively, the grounding conductor 3 may be arranged to cover the outer conductor 23 of the first coaxial cable 2A in addition to the outer conductor 23 of the second coaxial cable 2B.

### Fifth Embodiment

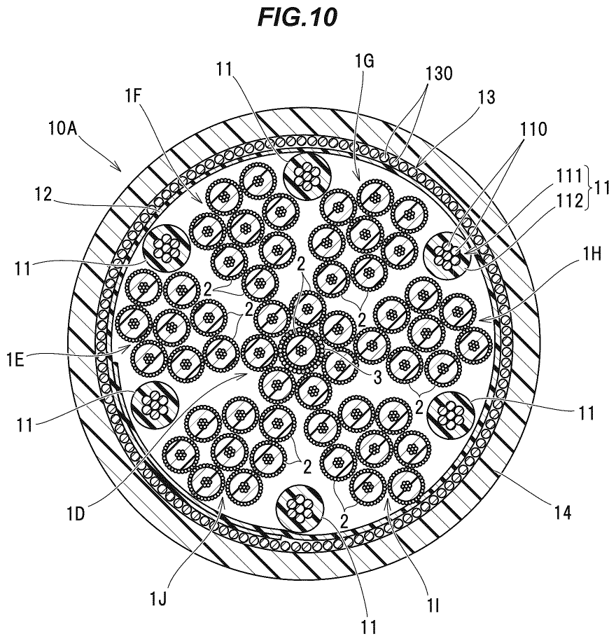

Next, the fifth embodiment of the present invention will be explained with reference to FIG. 10. FIG. 10 is a cross-sectional view illustrating a composite multicore cable 10A according to the fifth embodiment of the present invention. The composite multicore cable 10A which is a variant of the composite multicore cable 10 according to the first embodiment, is comprised of the first multicore cable 1D arranged at the center, the second to seventh multicore cables 1E to 1J arranged around the first multicore cable 1D, the plural power lines 11, the tape member 12, the shield layer 13 made of the plural shield wires 130, and the outer sheath 14. The configurations of the power lines 11, the tape member 12, the shield layer 13, and the outer sheath 14, are the same as the composite multicore cable 10 according to the first embodiment.

The first multicore cable 1D is the multicore cable 1 according to the first embodiment, with the tape member 4, the shield layer 5, and the sheath 6 being omitted. Among the plural coaxial cables 2 of the first multicore cable 1D, the coaxial cable 2 arranged at the center is covered by the grounding conductor 3. The outer conductor 23 of the plural coaxial cables 2 arranged around the coaxial cable 2 and the grounding conductor 3 is electrically grounded by contacting the grounding conductor 3 or the outer conductor 23 of another one of the coaxial cables 2 arranged in the immediate vicinity.

The second to seventh multicore cables 1E to 1J are made of the plural coaxial cables 2 stranded together. The plural coaxial cables 2 of the second to seventh multicore cables 1E to 1J are not covered by the grounding conductor 3. The outer conductors 23 of the plural coaxial cables 2 of the second to seventh multicore cables 1E to 1J are electrically grounded by contacting one another.

Each of the second to seventh multicore cables 1E to 1J has the outer conductor 23 of at least one coaxial cable 2 out of the plural coaxial cables 2 in contact with the outer conductor 23 of at least one coaxial cable 2 out of the plural coaxial cables 2 of the multicore cable 1D. Due to this, the outer conductors 23 of the plural coaxial cables 2 are electrically grounded.

With the composite multicore cable 10A, electrically grounding the grounding conductor 3 of the first multicore cable 1D allows the outer conductors 23 of all the coaxial cables 2 of the first to seventh multicore cables 1D to 1J to be electrically grounded. Therefore, an operation of connecting the outer conductor 23 of all the coaxial cables 2 to ground electrodes becomes unnecessary, and the terminal processing can be performed easily. The composite multicore cable 10A according to the fifth embodiment, has a configuration where only the first multicore cable 1D at the center has the grounding conductor 3. Alternatively, it may have a configuration where at least one of the first to seventh multicore cables 1D to 1J has the grounding conductor 3, for example.

### Summary of the Embodiments

Next, technical ideas understood from the above embodiments are described with reference to the reference numerals and the like used in the embodiments. However, each reference numeral in the following description does not limit the constituent elements in the scope of claims to the members and the like specifically shown in the embodiments.

According to the first feature, a multicore cable 1, 1A to 1D has coaxial cables 2, each of which has an inner conductor 21, an insulator 22 covering the inner conductor, and an outer conductor 23 arranged around the insulator 22, the outer conductor 23 is not covered (i.e., is exposed) by the insulator, the outer conductor 23 of some coaxial cables 2 out of the coaxial cables 2 are covered by a grounding conductor 3 which is to be electrically grounded, and the outer conductors 23 of the coaxial cables 2 are electrically grounded by contacting the grounding conductor 3 or the outer conductor 23 of another one of the coaxial cables 2.

According to the second feature, in the multicore cable 1, 1A to 1D as described in the first feature, the grounding conductor 3 is made by spirally winding grounding conductor wires 30.

According to the third feature, the multicore cable 1, 1A to 1D as described in the second feature, the outer conductors 23 of some coaxial cables 2 are made by spirally winding outer conductor wires 230 around an outer periphery of the insulator 23; and a spiral winding direction of the grounding conductor wires 30 and a spiral winding direction of the outer conductor wires 230 are opposite to each other.

According to the fourth feature, in the multicore cable 1, 1A to 1D as described in any one of the first to third features, at least five other coaxial cables 2, 2B to 2F are spirally arranged around at least one coaxial cable 2, 2A covered by the grounding conductor 3.

According to the fifth feature, in the multicore cable 1, 1A to 1D as described in any one of the first third feature, the coaxial cables 2 are covered by a sheath 6; and at least one coaxial cable 2, 2B out of the coaxial cables 2, arranged in the vicinity of the sheath 6, is covered by the grounding conductor 3.

### Additional Notes

As described above, the first to fifth embodiments of the present invention are explained. These embodiments do not limit the invention according to the scope of claims. Additionally, it should be noted that not all combinations of features are essential to the means for solving the problems of the invention.

Furthermore, the present invention is not limited to the above embodiments, but various modifications can be made without departing from the scope and spirit of the invention. For example, in the first to fourth embodiments, the multicore cables 1, 1A to 1C have the tape member 4 and the shield layer 5, but the tape member 4 or the shield layer 5 can be omitted depending on the environment or conditions of use.

1. A multicore cable comprising:
coaxial cables, each comprising an inner conductor, an insulator covering around the inner conductor, and an outer conductor arranged around the insulator, the outer conductor being exposed,
wherein the outer conductors of some of the coaxial cables are covered by grounding conductors that are to be electrically grounded, and
wherein each of the outer conductors of the coaxial cables is electrically grounded by contacting the grounding conductor or the outer conductor of another one of the coaxial cables.

2. The multicore cable according to claim 1, wherein the grounding conductor comprises grounding conductor wires that are spirally wound.

3. The multicore cable according to claim 2, wherein the outer conductors of some of the coaxial cables are composed of outer conductor wires spirally wound around an outer periphery of the insulator, and
wherein a spiral winding direction of the grounding conductor wires and a spiral winding direction of the outer conductor wires are opposite to each other.

4. The multicore cable according to claim 1, wherein at least five other coaxial cables are arranged spirally to surround at least one of the coaxial cables covered by the grounding conductor.

5. The multicore cable according to claim 1, wherein the coaxial cables are covered by a sheath, and
wherein at least one coaxial cable out of the coaxial cables, which is located in vicinity of the sheath, is covered by the grounding conductor.
